(19) United States
(12) Patent Application Publication
(10) Pub. No.: US 2013/0181562 A1
(43) Pub. Date: Jul. 18, 2013

(54) DUAL-ROTOR MACHINE

(71) Applicants: Jacek F. Gieras, Glastonbury, CT (US); Lubomir A. Ribarov, Windsor Locks, CT (US); Gregory I. Rozman, Rockford, IL (US)

(72) Inventors: Jacek F. Gieras, Glastonbury, CT (US); Lubomir A. Ribarov, Windsor Locks, CT (US); Gregory I. Rozman, Rockford, IL (US)

(73) Assignee: HAMILTON SUNDSTRAND CORPORATION, Windsor Locks, CT (US)

(21) Appl. No.: 13/351,562

(22) Filed: Jan. 17, 2012

(51) Int. Cl. H02K 16/02

(52) U.S. Cl. 310/114

(57) ABSTRACT

A dual rotor machine having a stator includes at least one excitation element, a first rotor located between the at least one excitation element and an axis, the first rotor configured to rotate about the axis, and a second rotor on the other side of the at least one excitation element from the axis, the second rotor configured to rotate about the axis.

### BACKGROUND OF THE INVENTION

Embodiments of the present invention pertain to the art of dual-rotor machines, and in particular, to dual-rotor generators and motors.

Dual-rotor electrical machines and electromagnetic devices include counter-rotating devices having two parts that rotate in opposite directions. Axial flux dual-rotor machines include a flat stator having a hole to receive a first shaft, and first and second rotors on either side of the stator that may be driven by the stator in opposite directions.

Axial flux dual-rotor machines suffer from various drawbacks including the formation of a three-dimensional (3D) magnetic circuit, difficulties in stacking the stator core, high costs in manufacturing laminated stator cores, fabrication difficulties in manufacturing a slotted stator core, high axial forces between the stator and rotors, difficulties in assembling the machine and maintaining a uniform air gap between the stator and the rotors, and limited mechanical contact between the rotors and the shaft.

### BRIEF DESCRIPTION OF THE INVENTION

Disclosed is a dual rotor machine having a stator having at least one winding, a first rotor located between the at least one winding and an axis, the first rotor configured to rotate about the axis, and a second rotor on the other side of the at least one winding from the axis, the second rotor configured to rotate about the axis.

Also disclosed is a system comprising a dual rotor machine including a stator having at least one winding, a first rotor located between the winding and an axis, the first rotor configured to rotate around the axis, and a second rotor on an opposite side of the winding from the axis, the second rotor configured to rotate about the axis. The system also includes at least one load connected to the dual rotor machine to be driven by the dual rotor machine.

### BRIEF DESCRIPTION OF THE DRAWINGS

The following descriptions should not be considered limiting in any way. With reference to the accompanying drawings, like elements are numbered alike:

FIG. 1 is a diagram of a radial flux dual-rotor machine according to one embodiment of the present invention;

FIG. 2 is a diagram of a radial-flux dual-rotor machine according to one embodiment;

FIG. 3 is a diagram of a radial-flux dual-rotor motor according to one embodiment;

FIGS. 4A and 4B depict a core of a radial-flux dual-rotor motor according to one embodiment;

FIGS. 5A and 5B illustrate windings of a radial-flux dual-rotor motor according to one embodiment;

FIG. 6 illustrates a transverse-flux dual-rotor machine according to one embodiment;

FIG. 7 illustrates a cross-section view of the transverse-flux dual-rotor machine according to one embodiment;

FIG. 8 illustrates another cross-section view of the transverse-flux dual-rotor machine according to one embodiment;

FIG. 9 illustrates a block diagram of a dual-rotor motor according to one embodiment of the present invention;

FIG. 10 illustrates a block diagram of a dual-rotor energy-transfer device according to one embodiment; and

FIG. 11 illustrates a block diagram of a dual-rotor generator according to an embodiment of the present invention.

### DETAILED DESCRIPTION OF THE INVENTION

A detailed description of one or more embodiments of the disclosed apparatus and method are presented herein by way of exemplification and not limitation with reference to the Figures.

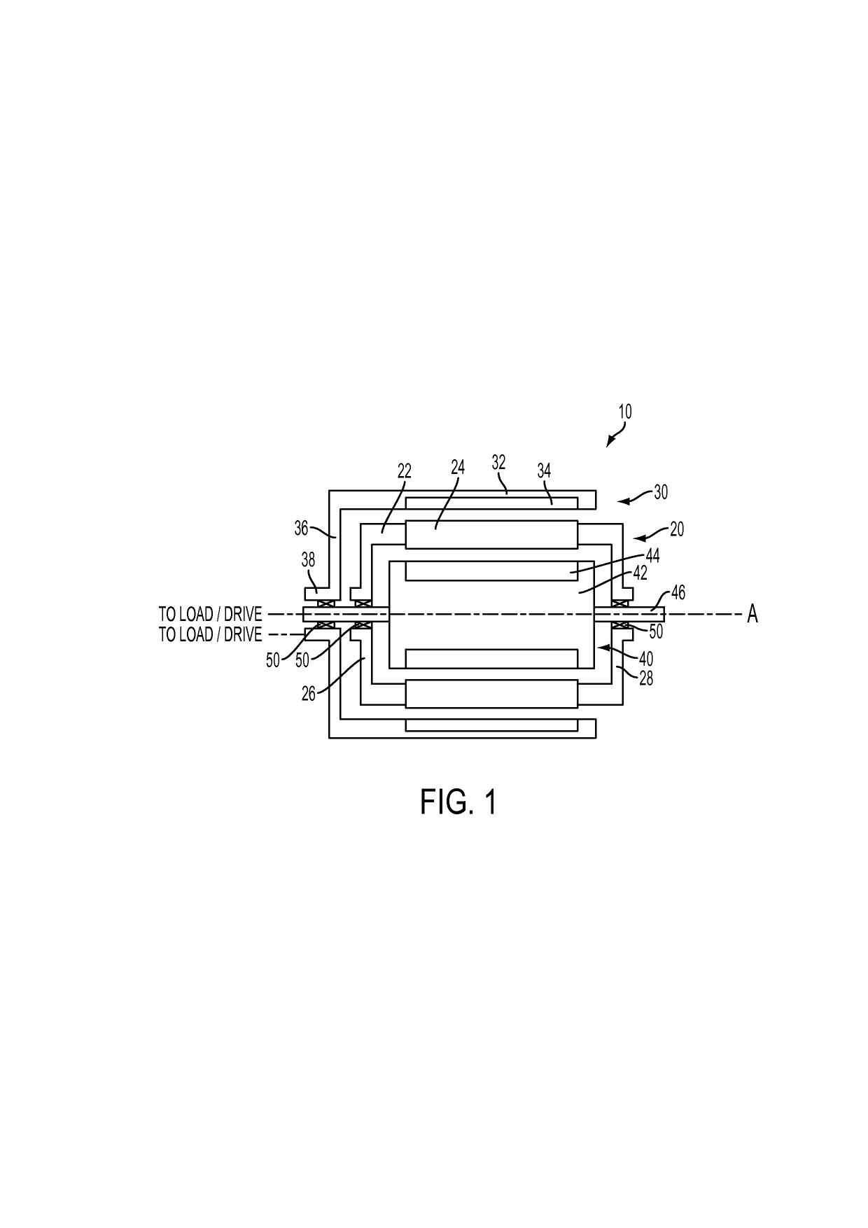

FIG. 1 illustrates a dual-rotor machine 10 according to one embodiment of the present invention. The dual-rotor machine 10 includes a stator 20, a first rotor 30, and a second rotor 40. The first and second rotors 30 and 40 rotate about a rotation axis A. The stator 20 includes a length portion 22 and radial portions 26 and 28 at the ends of the length portion 22 extending radially from the axis A. The length portion 22 may have a substantially cylindrical shape. The length portion 22 includes an excitation element 24. In one embodiment, the excitation element 24 includes a winding of one or more coils of conductive material. Current may be applied to the excitation element 24 to generate a magnetic field, or a magnetic field may be applied to the excitation element 24 from an external source to generate a current within the excitation element 24.

The first rotor 30 includes a length portion 32 and at least one radial portion 36 extending radially from the axis A. The length portion 32 may have a substantially cylindrical shape. The first rotor 30 includes an excitation element 34 located on or in the length portion 32. In one embodiment, the excitation element 34 is a permanent magnet. In other embodiments, the excitation element 34 may be a wound field coil or a cage winding. The first rotor 30 may be driven to rotate and to thereby cause the excitation element 34 to rotate about the excitation element 24 of the stator 20. In an embodiment in which the excitation element 34 is a permanent magnet, the magnetic field generated by the permanent magnet generates a current in the excitation element 24. Alternatively a current may be applied to the excitation element 24 of the stator to generate a magnetic field which interacts with the excitation element 34 of the first rotor 30 to cause the first rotor 30 to rotate.

The second rotor 40 includes a base portion 42 and an excitation element 44 located on or in an outer surface of the base portion 42. The base portion 42 may have a substantially cylindrical shape. In one embodiment, the excitation element 44 is a permanent magnet. In other embodiments, the excitation element may be a wound field coil or a cage winding. The second rotor 40 may be driven to rotate and to thereby cause the excitation element 44 to rotate about the excitation element 24 of the stator 20. In an embodiment in which the excitation element 44 is a permanent magnet, the magnetic field generated by the permanent magnet generates a current in the excitation element 24. Alternatively a current may be applied to the excitation element 24 of the stator to generate a magnetic field which interacts with the excitation element 44 of the second rotor 40 to cause the second rotor 40 to rotate.

The second rotor 40 includes a shaft 46, and the first rotor 30 includes a shaft 38. The shafts 38 and 46 may each rotate with respect to the stator 20 and with respect to each other. Bearings 50 may be located between the shafts 38 and 46 and the stator 20 to allow the shafts 38 and 46 to rotate with respect to the stator 20. One or more of the shafts 38 and 46 may be connected to a drive to drive the shaft 38 and/or 46 to rotate with respect to the stator 20. Alternatively, one or more of the shafts 38 and 46 may be connected to a load, and the excitation element 24 of the stator 20 may drive the first and/or second rotor(s) 30 and/or 40 to drive the load.

In one embodiment, the first and second rotors 30 and 40 are counter-rotating, so that the shafts 38 and 46 are also counter-rotating. In an alternative embodiment, the first and second rotors 30 and 40 rotate in the same direction. In some embodiments, the first and second rotors 30 and 40 rotate at different speeds to form an asynchronous electromagnetic circuit. For example, the excitation elements 34 and 44 may be cage windings to provide an asynchronous induction counter-rotating motor. In other embodiments, the first and second rotors 30 and 40 rotate at the same speed to form a synchronous electromagnetic circuit.

In the present specification and claims, the term “excitation element” refers to an element that utilizes a magnetic field to drive a rotor or to generate electrical current with a driven rotor. Examples include a coil winding, a cage winding, and a permanent magnet. The generation of the magnetic field may drive a motor or generate an electric current according to various embodiments.

While FIG. 1 illustrates a configuration of a dual-rotor machine in which both shafts 38 and 46 extend longitudinally in the same direction, in alternative embodiments, the shafts extend in opposite directions from each other.

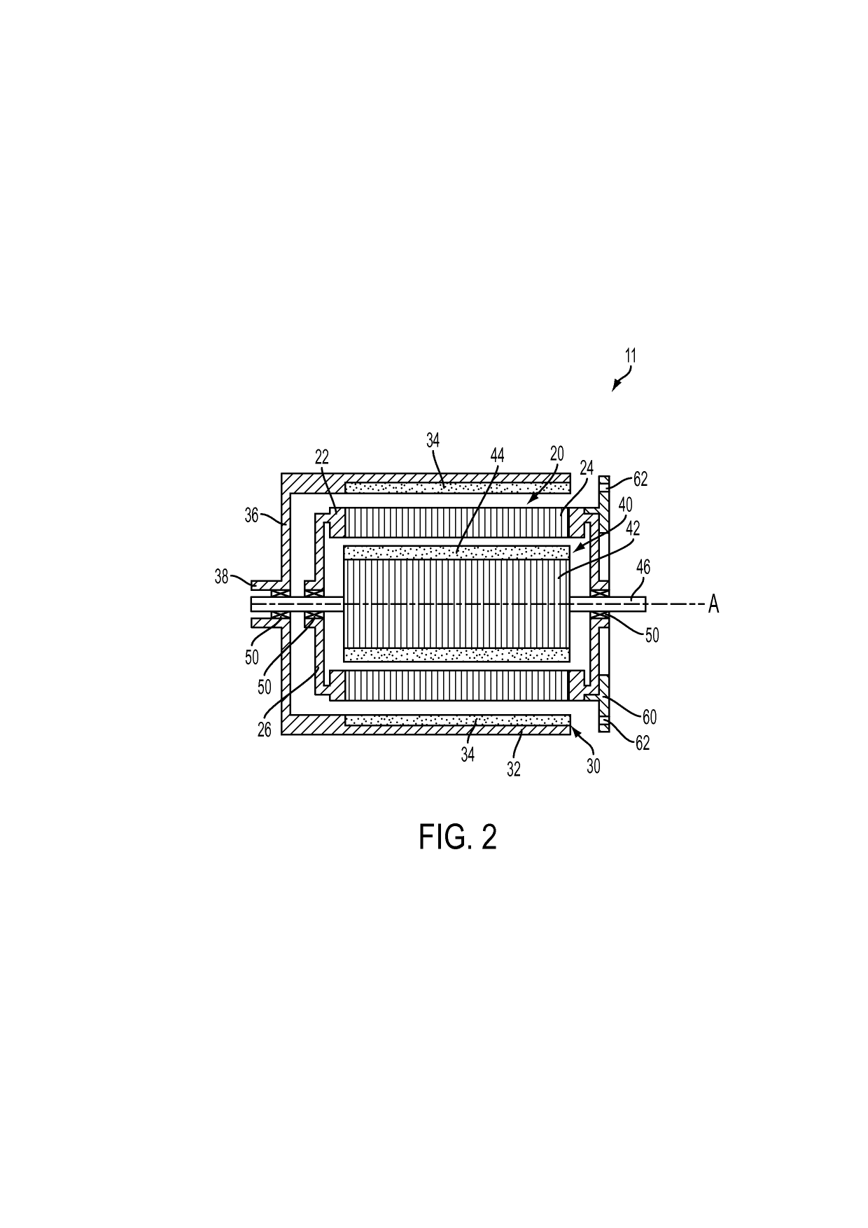

FIG. 2 illustrates a dual-rotor machine 11 that generates a radial magnetic flux according to an embodiment of the present invention. The dual-rotor machine 11 includes a mounting flange 60 to mount the stator 20 to a stationary surface. The mounting flange 60 may include one or more mounting holes 62 to receive fasteners such as bolts, or may be mounted to a surface by any other means.

In one embodiment, the excitation elements 34 and 44 are permanent magnets, and the first rotor 30 may not include any windings. The permanent magnets 34 and 44 may be located on a surface of the first and second rotors 30 and 40, or may be embedded within the length portion 34 and the base portion 42, respectively. The length portion 32 of the first rotor 30 may be a laminated or a solid material. In addition, the excitation element 24 of the stator 20 may be a laminated or soft magnetic composite (SMC) core including slots, and a multi-phase winding in the slots. For example, the multi-phase winding may be a three-phase winding. The base portion 42 of the second rotor 40 may be a ferromagnetic cylinder made of solid steel, laminations, or SMC, for example.

According to one embodiment, the dual-rotor machine 11 may generate power by driving the rotors 30 and 40 via the shafts 38 and 46, thereby generating current in a winding of the stator 20. According to another embodiment, the radial-flux dual-rotor machine 11 transfers power from one of the shafts 38 or 46 to the other. For example, shaft 38 may be driven by a force, which generates current in the winding of the stator 20. The current in the excitation element 24 of the stator 20 may generate a magnetic field that drives the second rotor 40. The excitation element 44 may be a permanent magnet, and the magnetic field generated by a winding of the excitation element 24 may apply a force to the excitation element 44, driving the shaft 46. According to another embodiment, the dual-rotor machine 11 drives the shafts 38 and 46 by generating a magnetic field with the excitation element 24.

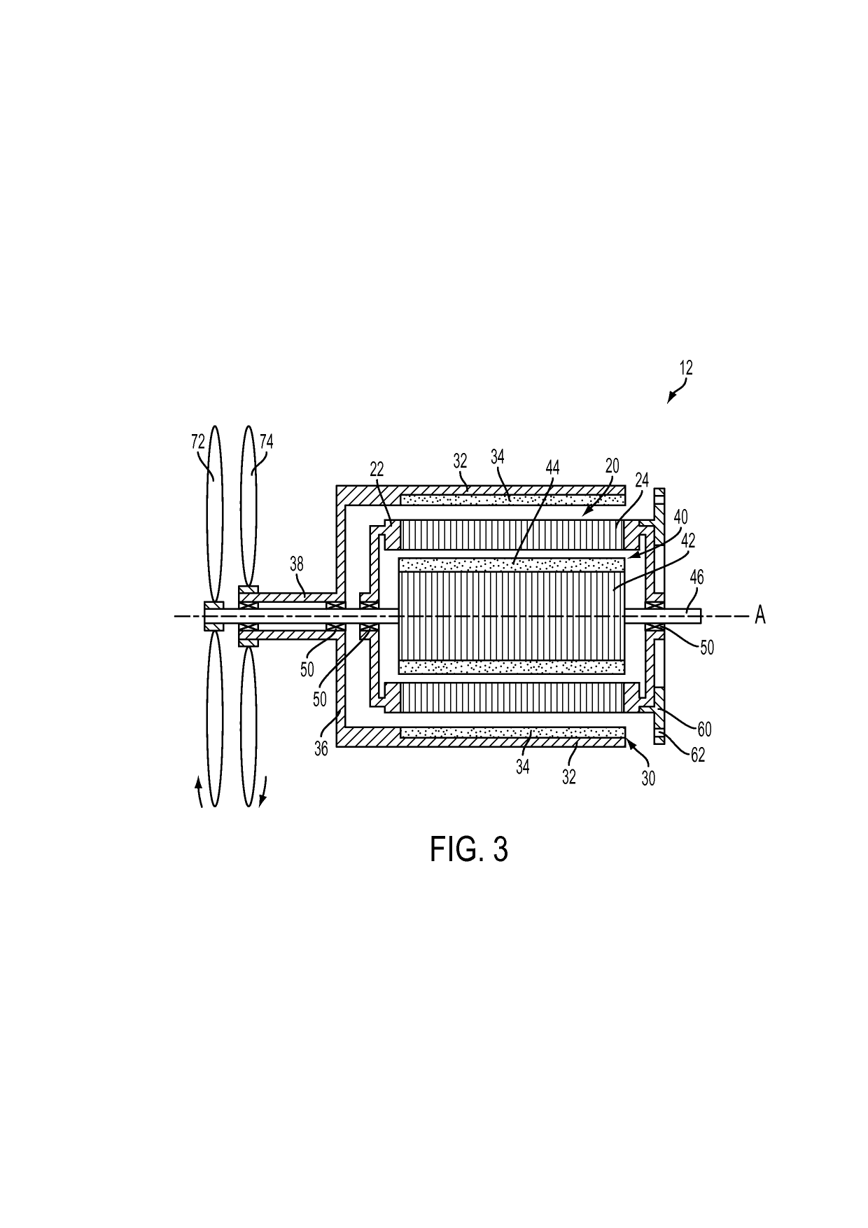

FIG. 3 illustrates an embodiment of the present invention in which the dual-rotor machine 12 is a counter-rotating motor. The dual-rotor machine 12 illustrated in FIG. 3 includes a first blade 74 connected to the first shaft 38 and a second blade 72 connected to the second shaft 46. The first and second blades 74 and 72 may each represent blades of a propeller, for example. In other words, the first and second blades 74 and 72 represent one blade of a plurality of blades that surround the first shaft 38 and the second shaft 46. The excitation element 24 of the stator 20 generates magnetic fields to drive the first shaft 38 in a first direction and the second shaft 46 in the opposite direction. In this manner, the blades 72 and 74 of the contra-rotating propellers are driven in opposing directions. The dual-rotor machine 12 according to the embodiment of FIG. 3 may be used to drive the blades 72 and 74, and the corresponding propellers and shafts 38 and 46, for any number of applications, including aircraft, watercraft, ground-based vehicles, and ground-based structures. In addition, when configured as a power generator, the blades 72 and 74 may be driven by air, water, or any other fluid to drive the shafts 38 and 46 to generate an electrical current in the excitation element 24 of the stator 20.

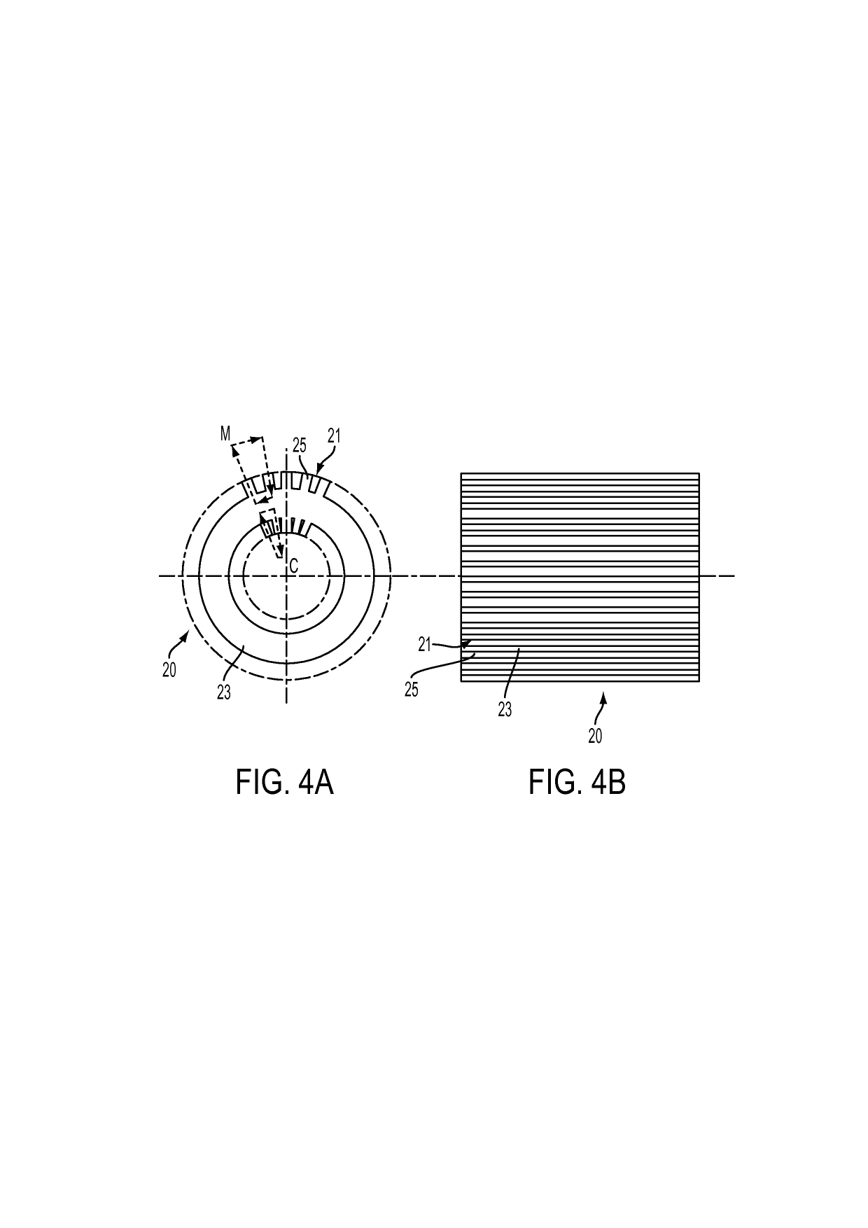

FIGS. 4A and 4B illustrate an end view and side view of the stator 20 according to one embodiment of the invention. The stator 20 includes a slotted core having a base portion or yoke 23, teeth 25 protruding from the base portion or yoke 23, and slots 21 between the teeth 25. The each one of the teeth 25 may extend radially from a center point C of the stator 20. Each one of the teeth 25 may extend across the base portion 23 to protrude both toward the center point C from the base portion 23 and away from the center point C from the base portion 23. The excitation element 24 of FIG. 1 includes windings (not shown in FIGS. 4A and 4B) that run down the length of the slots 21.

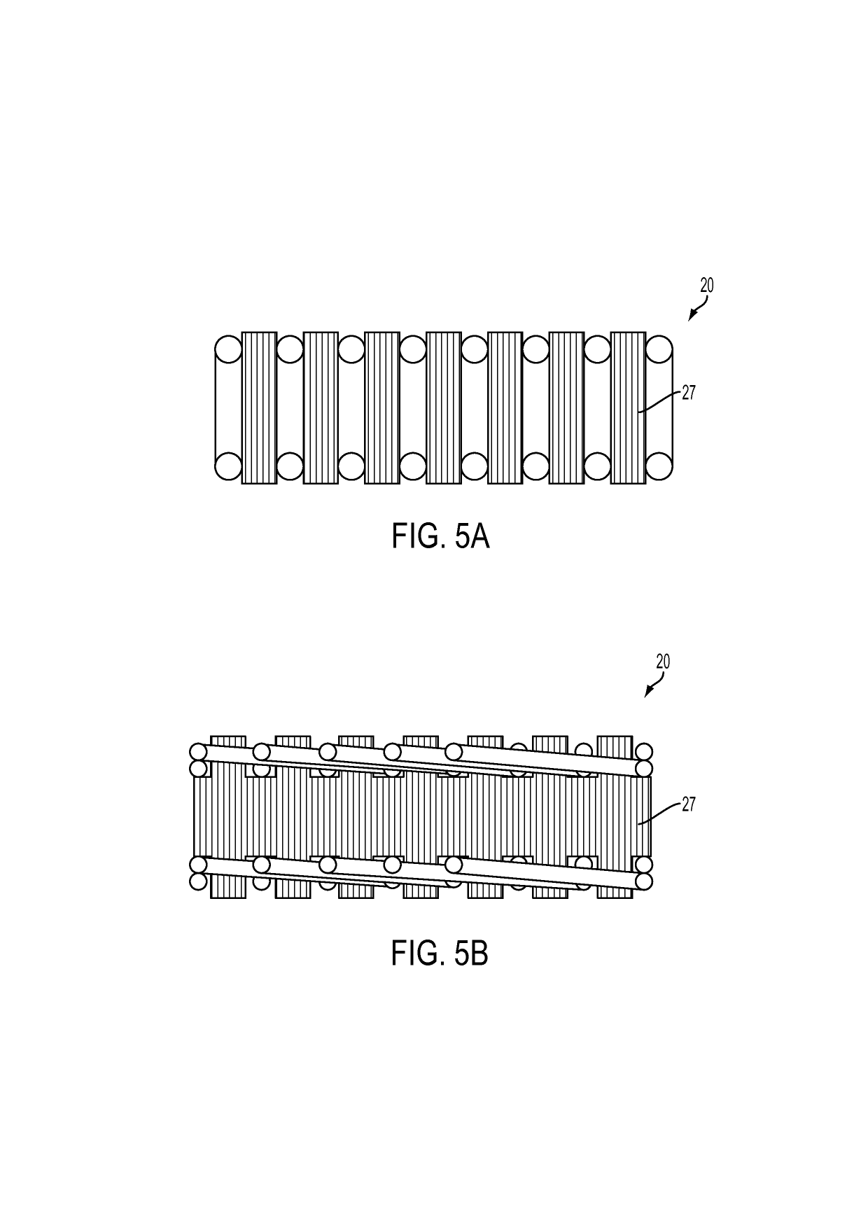

FIGS. 5A and 5B illustrate stator polyphase windings that are spread flat for purposes of illustration only. As illustrated in FIG. 5A, the excitation element 24 of the stator 20 may include Gramme's type single windings 27. Alternatively, FIG. 5B illustrates the excitation element 24 as two double-layer windings consisting of distributed-parameter coils 27. According to an alternative embodiment, the excitation element 24 may include concentrated-parameter, non-overlapping coils.

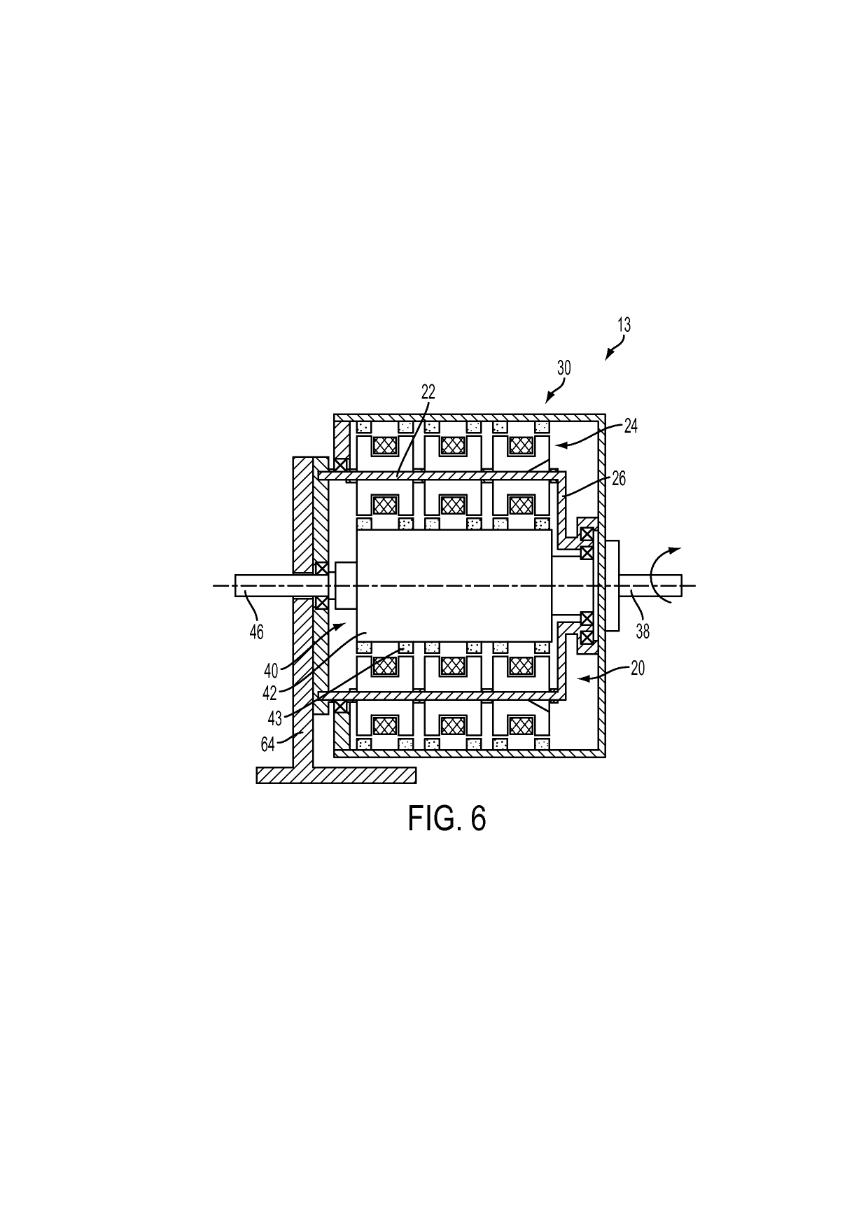

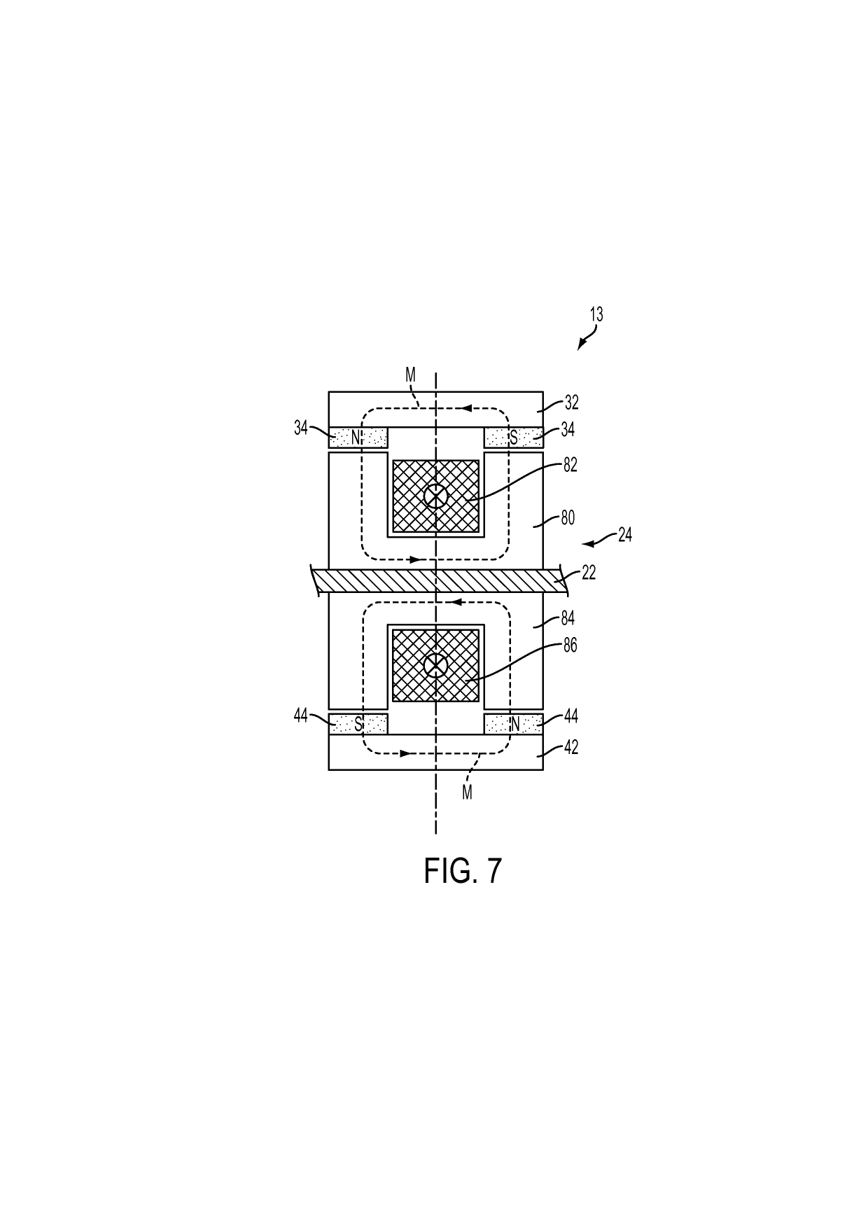

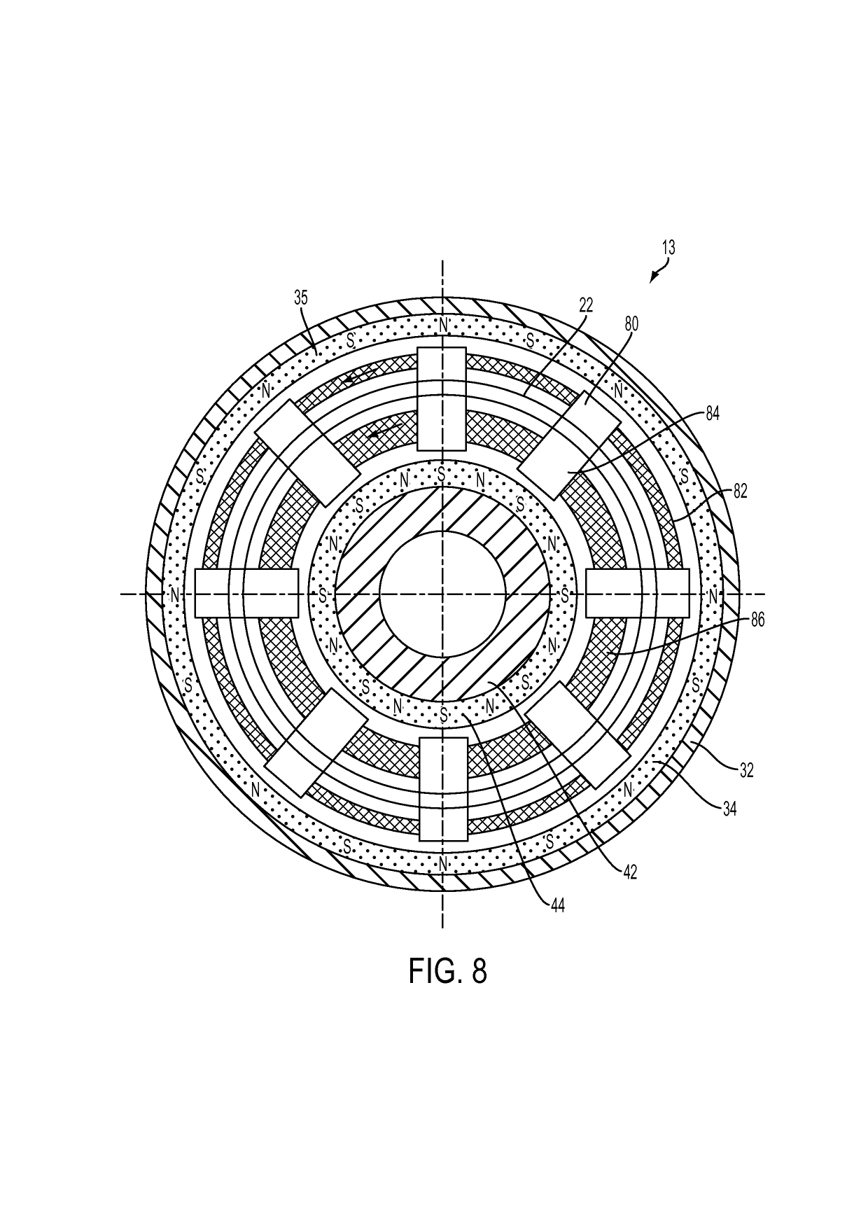

FIG. 6 illustrates a dual-rotor machine 13 according to an embodiment of the present invention and shall be described with further reference to FIGS. 7 and 8. The dual-rotor machine 13 is a transverse-flux machine. The dual-rotor machine 13 may have a stator 20 mounted to a surface by a mounting bracket 64. The length portion 22 of the stator 20 has a cylindrical shape. The excitation element 24 of the stator 20 includes a plurality of U-shaped cores 80 and a coil 82 that circumscribes the length portion 22 of the stator 20. The excitation element 24 interacts with the excitation element 34 of the first rotor 30 to generate a current in the excitation element 24 or to drive the rotor 30 and the shaft 38. As illustrated in FIG. 7, the excitation elements 34 may be permanent magnets. In one embodiment, the permanent magnets are positioned to correspond to ends of the U-shaped cores 80, such that a permanent magnet of one polarity is positioned at one end of the U-shaped core 80 and a permanent magnet of an opposing polarity is positioned at the other end of the U-shaped core 80. As illustrated, the permanent magnets are positioned to correspond to ends of the U-shaped cores 80, such that a permanent magnet of one polarity (e.g. element 34 bearing the label N) is positioned at one end of the U-shaped core 80 and a permanent magnet of an opposing polarity (e.g. element 34 bearing the label S) is positioned at the other end of the U-shaped core 80. In one embodiment, the first rotor 30 does not include any windings.

The stator 20 also includes a plurality of U-shaped cores 84 and a wound coil 86 on the inside surface of the length portion 22. The U-shaped cores 84 and the wound coil 86 interact with the excitation elements 44 of the second rotor 40 to generate current in the wound coil 86 or to drive the second rotor 40 and the shaft 46. The excitation elements 44 may be located on an outer surface of the base portion 42 or may be embedded within the base portion 42. In one embodiment, the base portion 42 may be a ferromagnetic cylinder and the excitation elements 44 may be permanent magnets. As illustrated, the permanent magnets are positioned to correspond to ends of the U-shaped cores 84, such that a permanent magnet of one polarity (e.g. element 44 bearing the label N) is positioned at one end of the U-shaped core 84 and a permanent magnet of an opposing polarity (e.g. element 44 bearing the label S) is positioned at the other end of the U-shaped core 84. FIG. 7 illustrates magnetic flux M flows through the first and second rotors 30 and 40 and the stator 20.

As illustrated in FIG. 8, the excitation elements 34 and 44 may be permanent magnets having alternating poles (shown by N and S reference notations) in a circumferential direction. The permanent magnets may be one continuous layer, as illustrated in FIG. 8, or may comprise segments of different polarity permanent magnets positioned end-to-end. While FIG. 8 illustrates a transverse-flux machine 13 having only eight pole-pairs, it is understood that the transverse-flux machine may include any number of pole-pairs. For example, by increasing the number of poles, the transverse-flux machine may have an improved performance.

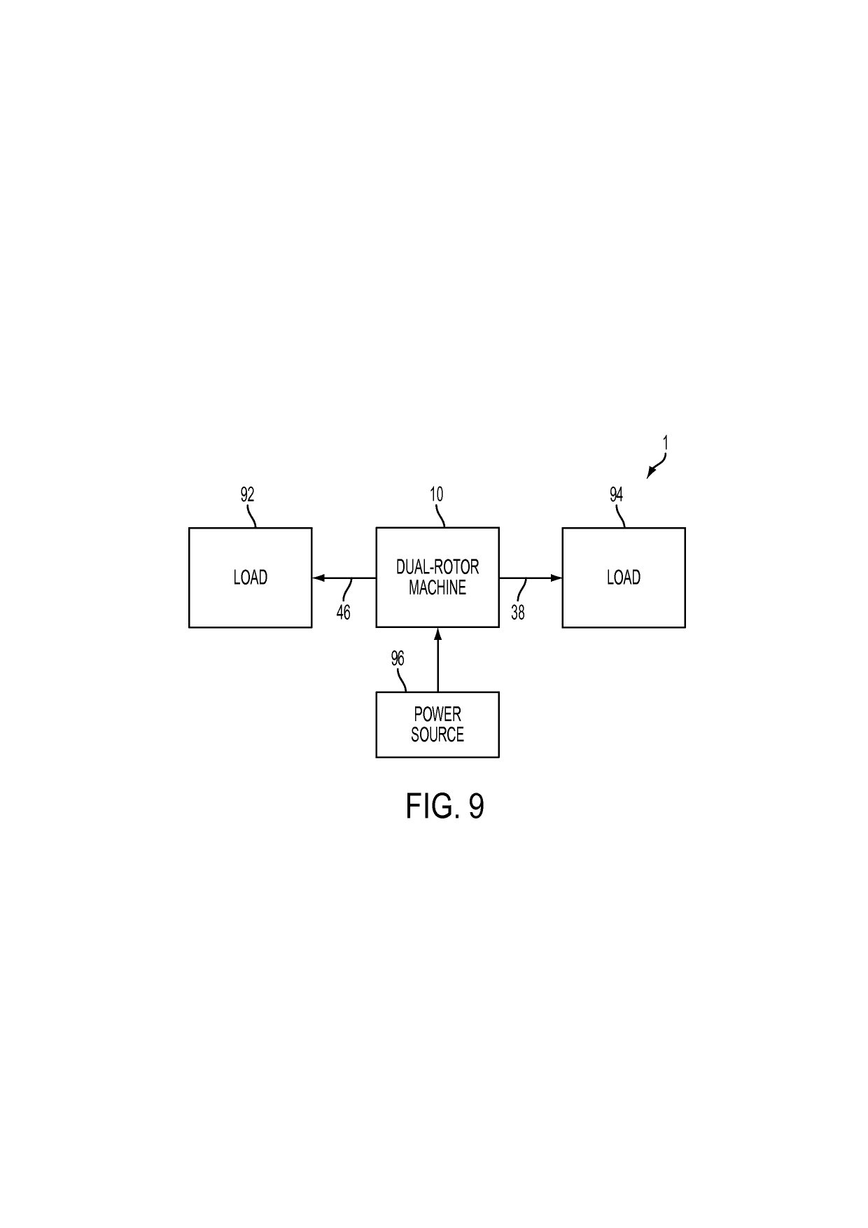

It is understood that the radial-flux dual rotor machine 11 (FIG. 2), the radial-flux dual-rotor motor 12 (FIG. 3), and the transverse-flux dual-rotor machine 13 (FIG. 6) are all just specific types of dual-rotor machines 10. FIGS. 9-11 illustrate systems utilizing the dual-rotor machines 10 of the above-described embodiments. It shall be understood that the discussion of FIGS. 9-11 may include reference to FIG. 1 from time to time.

FIG. 9 illustrates a motor system 1 that includes the dual-rotor machine 10 having loads 92 and 94 connected to the shafts 46 and 38 of the second rotor 40 and the first rotor 30, respectively. A power source 96 may provide power to the excitation element 24 of the stator 20, which may interact with the excitation elements 34 and 44 of the first and second stators 30 and 40, respectively, to drive the shafts 38 and 46, respectively. The shafts 38 and 46 may drive the loads 92 and 94. In the embodiment illustrated in FIG. 9, the excitation elements 34 and 44 of the first and second rotors 30 and 40 may be permanent magnets or cage windings, for example.

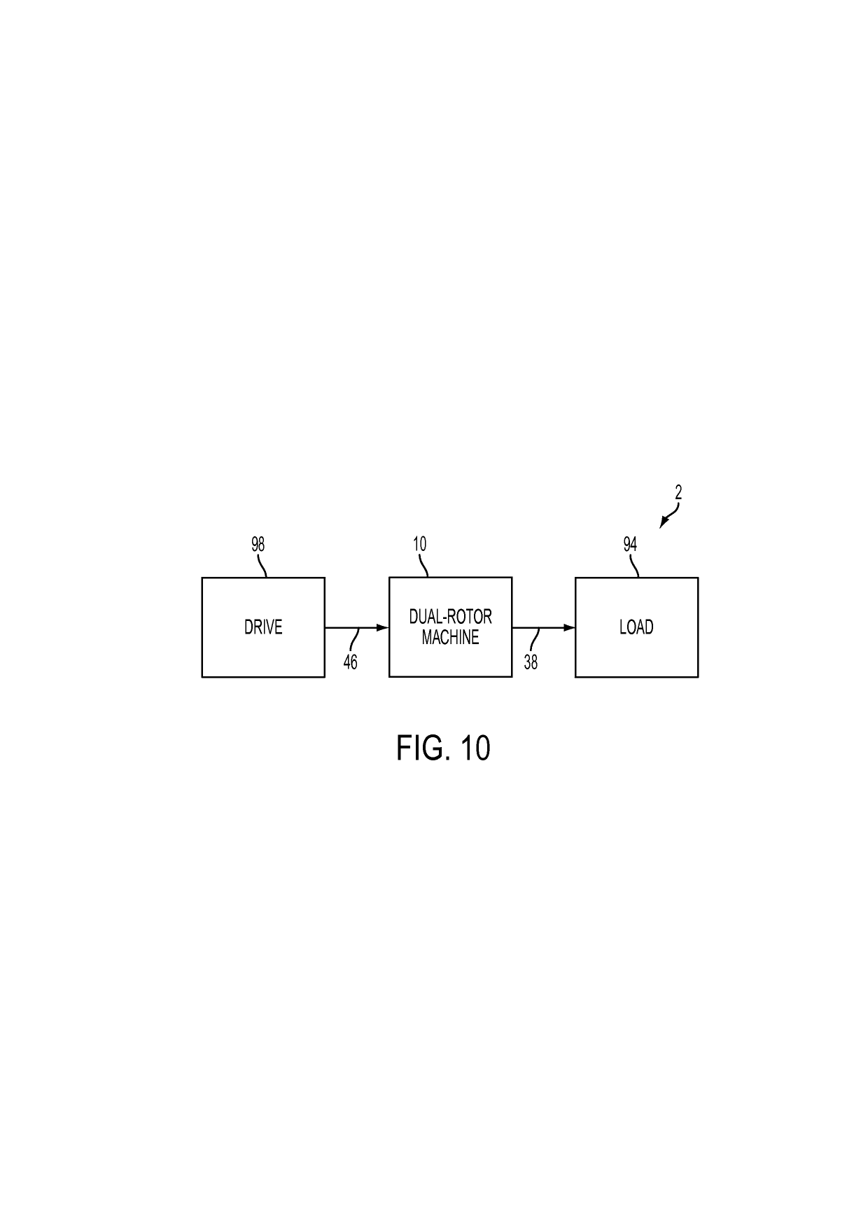

FIG. 10 illustrates a power transfer system 2 according to an embodiment of the present invention. In a power transfer system 2, one shaft is driven by an external force to generate a magnetic field in the stator 20. The stator 20 drives the other shaft. In FIG. 10, for example, the shaft 46 of the second rotor 40 is connected to a drive 98 which drives the shaft 46. The rotation of the second rotor 40 generates a magnetic field in the excitation element 24 of the stator 20, and the magnetic field interacts with the excitation element 34 of the first rotor 30 to drive the first rotor 30 and the shaft 38. The shaft 38 may be connected to a load 94 to drive the load 94.

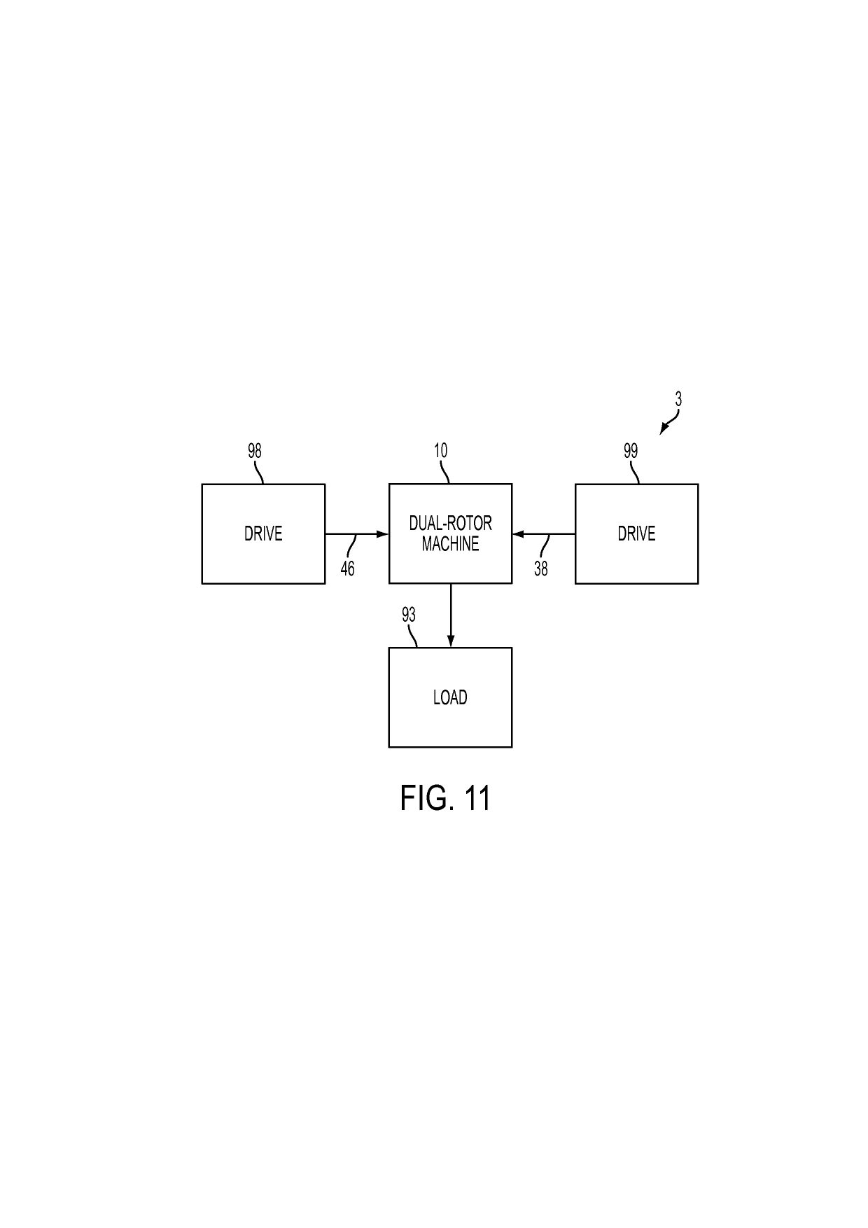

When functioning as a generator, one or both of the rotors 30 and 40 generates an electromotive force (EMF) in the excitation element 24 of the stator 20, which provides the current to an electrical load. For example, FIG. 11 illustrates a generator system 3 in which each of the shafts 38 and 46 is driven by drives 99 and 98, respectively. The rotation of the shafts 38 and 46 rotates the excitation elements 34 and 44, generating an electrical current in excitation element 24 of the stator 20. The excitation element 24 is electrically connected to a load 93 to provide electrical power to the load 93.

While FIGS. 9-11 have illustrated different types of systems utilizing a dual-rotor machine 10 according to embodiments of the present invention, it is understood that the dual-rotor machine 10 may also combine elements of the systems 1, 2, and 3. For example, a motor system 1 that drives loads 92 and 94 may also be configured such that the loads may act as drives 98 and 99 to generate power and to provide power to a load 93. Similarly, in a power transfer system 2, the drive 98 may both transfer power to a load 94 via the shaft 38, and also generate electrical power to transmit to an electrical load 93.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. A dual rotor machine, comprising:
a stator having a winding;
a first rotor located at least partially within the winding and configured to rotate around an axis; and
a second rotor surrounding at least a portion of the winding, the second rotor configured to rotate about the axis in a direction opposite the first rotor.

2. The dual rotor machine of claim 1, wherein the stator comprises a laminated stator core.

3. The dual rotor machine of claim 1, wherein the first rotor includes a first excitation element to interact with the winding of the stator, and
the second rotor includes a second excitation element to interact with the winding of the stator.

4. The dual rotor machine of claim 3, wherein at least one of the first excitation element and the second excitation element is a permanent magnet.

5. The dual rotor machine of claim 3, wherein at least one of the first excitation element and the second excitation element is a cage winding.

6. The dual rotor machine of claim 3, wherein the stator has a substantially cylindrical length portion,
the winding of the stator includes at least one first winding that circumscribes an outer surface of the length portion and at least one second winding extending around an inner circumference of an inside surface of the length portion, and
the first and second excitation elements extend circumferentially over the surfaces of the at least one first winding and the at least one second winding, respectively.

7. The dual rotor machine of claim 6, wherein at least one of the first and second excitation elements is a magnetic layer having alternating polarities in a circumferential direction.

8. The dual rotor machine of claim 3, wherein the stator has a substantially cylindrical length portion comprising a plurality of slots, and
the winding includes at least one first winding extending a length of the plurality of slots of the length portion.

9. The dual rotor machine of claim 1, wherein each of the stator, the first rotor, and the second rotor has a substantially cylindrical length portion.

10. The dual rotor machine of claim 9, wherein the winding includes at least one winding extending along each of an inner surface and an outer surface of the length portion of the stator,
the first excitation element is located on an inside surface of the first rotor, and
the second excitation element is located on an outside surface of the second rotor.

11. The dual rotor machine of claim 9, wherein the first rotor includes a first shaft configured to rotate around the axis, and the second rotor includes a second shaft configured to rotate around the axis.

12. The dual rotor machine of claim 11, wherein the first shaft includes an opening to receive the second shaft therein.

13. The dual rotor machine of claim 1, wherein the first and second rotors are configured to rotate at different speeds.

14. The dual rotor machine of claim 1, wherein the first and second rotors are configured to rotate at the same speed.

15. A dual rotor machine, comprising:
a stator having a winding;
a first rotor located at least partially within the winding and configured to rotate about an axis, the first rotor having a first excitation element to generate an electromotive force (EMF) in the winding; and
a second rotor surrounding at least a portion of the winding, the second rotor configured to rotate about the axis, the second rotor having a second excitation element,
wherein at least one of the first and second excitation elements is configured to generate a transverse flux EMF in the winding.

16. The dual rotor machine of claim 15, wherein the stator has a substantially cylindrical length portion,
the winding of the stator includes at least one first winding that circumscribes an outer surface of the length portion and at least one second winding extending around an inner circumference of an inside surface of the length portion, and
the first and second excitation elements extend circumferentially over the surfaces of the at least one first winding and the at least one second winding, respectively.

17. A system, comprising:
a dual rotor machine, comprising:
a stator having at least one winding;
a first rotor located between the at least one winding and an axis, the first rotor configured to rotate about the axis; and
a second rotor on an opposite side of the at least one winding from the axis, the second rotor configured to rotate about the axis in a direction opposite to the first rotor; and
at least one load connected to the dual rotor machine to be driven by the dual rotor machine.

18. The system of claim 17, wherein the first rotor includes a first shaft configured to rotate around the axis, and the second rotor includes a second shaft configured to rotate around the axis, and
the at least one load is connected to at least one of the first and second shafts to be driven by the at least one of the first and second shafts.

19. The system of claim 18, further comprising a drive connected to the other one of the first and second shafts,
wherein the drive is configured to rotate the one of the first and second shafts to generate a magnetic field in the at least one winding, and
the at least one winding is configured to drive the other one of the first and second shafts.

20. The system of claim 17, wherein the at least one load is an electrical load connected to the stator,
wherein at least one of the first and second rotors includes an excitation element configured to interact with the at least one winding to supply power to the electrical load.
